(19) United States
(12) Patent Application Publication
(10) Pub. No.: US 2008/0135794 A1
(43) Pub. Date: Jun. 12, 2008

(54) ROTARY VALVE

(76) Inventors: HAIM SHNIDER, ROSH PINA (IL); SHAHAR DROR, Reut (IL); OMER VULKAN, KIBBUTZ MOSHAVEI SADE (IL)

Correspondence Address: DEBORAH A. GADOR, P.O. BOX 4133, GANEL TIKVA, 55900, omitted

(21) Appl. No.: 11/567,231

(22) Filed: Dec. 6, 2006

(51) Int. Cl. F16K 5/06

(52) U.S. Cl. 251/315.1

(57) ABSTRACT

A rotary valve having a fluid inlet and a fluid outlet, the rotary valve including a housing for mounting in a fluid line controlling an hydraulic or pneumatic system, and a ball assembly mounted in the housing, the ball assembly including: at least two intersecting fluid flow passageways; and a check valve mounted in an inlet of one of the passageways; the ball assembly and the housing being configured and adapted to permit fluid flow through the housing from the inlet to the outlet in all positions of the ball assembly, and to permit fluid flow through the housing from the outlet to the inlet in all except one position of the ball assembly, in which one position the check valve maintains pressure in the fluid line for locking the hydraulic or pneumatic system.

### FIELD OF THE INVENTION

The present invention relates to anti-theft devices, in general and, in particular, to anti-theft devices of the immobilizer type for motor vehicles.

### BACKGROUND OF THE INVENTION

Vehicle theft is a problem around the globe. In order to prevent theft, a wide variety of devices have been developed, ranging from manual locks to electronic immobilizers which prevent, for example, the flow of gas to the motor, or disconnect the power to various electrical systems of the vehicle. Some of these devices are described in the following patents: U.S. Pat. No. 3,645,352, U.S. Pat. No. 3,653,406, U.S. Pat. No. 3,870,274, U.S. Pat. No. 3,872,953, U.S. Pat. No. 4,579,202, U.S. Pat. No. 4,793,661, U.S. Pat. No. 4,881,615, and U.S. Pat. No. 5,259,665.

It has been found, however, that these conventional anti-theft devices can be by-passed, neutralized or removed, leaving the vehicle with no protection.

One solution to this problem was proposed in U.S. Pat. No. 5,375,684. U.S. Pat. No. 5,375,684 describes a brake release lock including a first connecting element for connection to the master cylinder of a braking system, and a second connecting element for connection to the wheel cylinders of the braking system. A first passageway is provided connecting the first and second elements, having a valve seat and bore for a check valve spring-biased against the seat and configured in such a way as to permit fluid to flow from the master cylinder to the wheel cylinders, but to prevent fluid from returning from the wheel cylinders to the master cylinder. The device further includes a second passageway connecting the first and second connecting elements, bypassing the first passageway, and a solenoid valve responsive to signals producible by an authorized user of the vehicle, for cutting off the second passageway after the vehicle has been parked, and for re-establishing the second passageway prior to driving off the vehicle.

This device is very complicated to assemble and maintain, and includes the use of bi-level passageways, i.e., not co-planar and non-intersecting. These passageways, in the patented design, are very difficult, to seal. More troublesome is the fact that it is possible for this device to assume a position, during driving, which does not allow fluid to pass through the valve and reach the wheel cylinders, thereby preventing a legitimate driver from applying the brakes and possibly causing an accident. Moreover, if the tube from the master cylinder to the wheel cylinders is cut, the other brakes (i.e., handbrake, parking brake) can still work. Even if all the brake fluid lines are neutralized, the thief can still take the car and use the parking brake for stopping.

Accordingly, there is a long felt need for a reliable system for preventing theft of vehicles, and it would be very desirable is such a system provided improved safety for legitimate drivers of the vehicle.

### SUMMARY OF THE INVENTION

The present invention relates to a rotary valve for use in hydraulic and/or pneumatic systems, which permits selective closure of a fluid line in the system.

In accordance with one embodiment of the present invention, a system is provided to prevent vehicle theft while the vehicle is parked, by locking one or more systems in the vehicle, thereby preventing their normal functioning.

In particular, the present invention relates to a valve for use in an anti-theft system which limits fluid flow through a selected fluid line in a selected vehicle system, so as to lock a crucial hydraulic or pneumatic system in a motor vehicle, most particularly the brakes. The rotary valve includes a ball assembly characterized by permitting fluid flow through the valve in one direction at all times, e.g., to permit a driver to apply the brakes, and permitting fluid flow through the valve in two directions in all except one position, i.e., so as to permit a driver to release the brakes.

There is provided, according to the present invention, a rotary valve having a fluid inlet and a fluid outlet, the rotary valve including a housing for mounting in a fluid line controlling an hydraulic or pneumatic system, and a ball assembly mounted in the housing, the ball assembly including: at least two intersecting fluid flow passageways; and a check valve mounted in an inlet of one of the passageways; the ball assembly and the housing being configured and adapted to permit fluid flow through the housing from the fluid inlet to the fluid outlet in all positions of the ball assembly, and to permit fluid flow through the housing from the fluid outlet to the fluid inlet in all except one position of the ball assembly, in which one position the check valve maintains pressure in the fluid line for locking the hydraulic or pneumatic system.

It is a particular feature of the invention that there is an open fluid passage from the fluid inlet to the fluid outlet in every position of the ball assembly element relative to the housing, but only one position in which fluid flow is prevented in the opposite direction. Preferably, the rotary valve is coupled to a controller for controlling rotation of the ball assembly.

According to a preferred embodiment, the housing includes the fluid inlet and the fluid outlet, and the valve further includes a first annular seal mounted in the housing adjacent the fluid inlet, a second annular seal mounted in the housing adjacent the fluid outlet, the second seal having a larger inner diameter than the first seal, the ball assembly is mounted in the housing between the first seal and the second seal, the ball assembly including: first and second opposing truncated sides; a first fluid flow passageway extending between the first and second truncated sides, and permitting bi-directional fluid flow therethrough from the first truncated side to the second truncated side and in reverse; a second fluid flow passageway extending through the ball assembly, intersecting the first fluid flow passageway, and having a valve seat and a poppet mounted at one end of the second passageway forming the check valve, to prevent, together with the second seal, fluid flow from the fluid outlet to the fluid inlet in the one position of the ball assembly; a poppet retaining element mounted in the ball assembly; and further comprising means for rotating the ball assembly between a bi-directional fluid flow position and the one position.

There is further provided according to the present invention an anti-theft system including at least one valve as described above, coupled to a controller for selective rotation of the ball assembly element. Preferably, the system includes two or more such valves, and further includes means for coupling all of the valves for synchronous operation/rotation.

If desired, a remote control device, a biosensor, a key pad or a code pad may be used to arm the system.

Most preferably, the system further includes means for neutralizing the handbrake of the vehicle, as well, so that all the brakes in the vehicle are locked.

There is also provided according to the present invention a method for forming a rotary valve including providing a rotary valve housing having a fluid inlet and a fluid outlet, for mounting in a fluid line controlling an hydraulic or pneumatic system, mounting a ball assembly in the housing, the ball assembly including: at least two intersecting fluid flow passageways; and a check valve mounted in one end of one of the passageways; the ball assembly and the housing being configured and adapted to permit fluid flow through the housing from the fluid inlet to the fluid outlet in all positions of the ball assembly, and to permit fluid flow through the housing from the fluid outlet to the fluid inlet in all except one position of the ball assembly, in which one position the check valve maintains pressure in the fluid line for locking the hydraulic or pneumatic system.

There is also provided, according to the invention, a method for forming an anti-theft system, the method including providing at least one rotary valve including: a housing having a fluid inlet and a fluid outlet for coupling in a fluid line, a first annular seal mounted in the housing adjacent the fluid inlet; a second annular seal mounted in the housing adjacent the fluid outlet, the second seal having a larger inner diameter than the first seal; a ball assembly mounted in the housing between the first seal and the second seal, the ball assembly including: first and second opposing truncated sides; a first fluid flow passageway extending between the first and second truncated sides, and permitting bi-directional fluid flow therethrough from the first truncated side to the second truncated side and in reverse; a second fluid flow passageway extending through the ball assembly, intersecting the first fluid flow passageway, and having a valve seat and a poppet mounted at one end thereof to form a check valve, to prevent, together with the second seal, fluid flow from the fluid outlet to the fluid inlet in one position of the ball assembly; a poppet retaining element mounted in the ball assembly; and coupling means for rotating the ball assembly between a bi-directional position and the one position to the ball assembly; and coupling an arming/disarming controller for controlling the means for rotating to the means for rotating.

According to a preferred embodiment, the method further includes providing a handbrake neutralizing mechanism and coupling it to the arming/disarming controller for synchronized operation.

### BRIEF DESCRIPTION OF THE DRAWINGS

The present invention will be further understood and appreciated from the following detailed description taken in conjunction with the drawings in which:

FIG. 1 is a schematic sectional illustration of an anti-theft system constructed and operative in accordance with one embodiment of the present invention;

FIGS. 2a to 2h are schematic illustrations of an anti-theft valve according to one embodiment of the invention in operation;

FIG. 3a is a schematic illustration of a ball assembly for a rotary valve according to another embodiment of the invention;

FIGS. 3b and 3c are illustrations of multiple valve anti-theft systems, according to the invention;

FIGS. 4a, 4b and 4c are schematic illustrations of alternative valve locations for anti-theft systems according to the invention;

FIGS. 5a and 5b are schematic illustrations of anti-theft systems, according to additional embodiments of the invention;

FIG. 6 is a block diagram illustration of an anti-theft system, according to a preferred embodiment of the invention;

FIGS. 7a, 7b and 7c are schematic plan, top and alternative top illustrations of a handbrake/parking brake disengaging mechanism according to one embodiment of the invention;

FIGS. 8 and 9 are block diagram illustrations of anti-theft systems, according to further embodiments of the invention;

FIG. 10a is a schematic illustration of a rotary valve according to another embodiment of the invention;

FIG. 10b is a schematic illustration of a rotary valve according to an alternative embodiment of the invention;

FIG. 11a is a schematic illustration of a rotary valve according to a further embodiment of the invention;

FIG. 11b is a schematic illustration of a rotary valve according to a further embodiment of the invention;

FIG. 12a is a schematic illustration of a rotary valve according to another embodiment of the invention;

FIG. 12b is a schematic illustration of the rotary valve of FIG. 12a in another position.

### DETAILED DESCRIPTION OF THE INVENTION

The present invention relates to a rotary valve for use in hydraulic and/or pneumatic systems, which permits selective closure of a fluid line in the system. The rotary valve is particularly suited for anti-theft systems for motor vehicles, and will be described herein with reference thereto. However, it will be appreciated that the valve can be utilized in any other hydraulic or pneumatic system having a fluid line.

The invention will be described, in particular, with reference to a novel anti-theft valve permitting locking of a fluid line in the vehicle, whether hydraulic or pneumatic, when the vehicle is parked. The system enables normal use of the lockable element or system (e.g., the normal use of the braking system) during driving, but locks the element, whether brakes, steering wheel, fuel line, or other element, when the vehicle is parked and the system is armed. The system includes at least one ball assembly having a check valve therein, and a controller for the ball assembly.

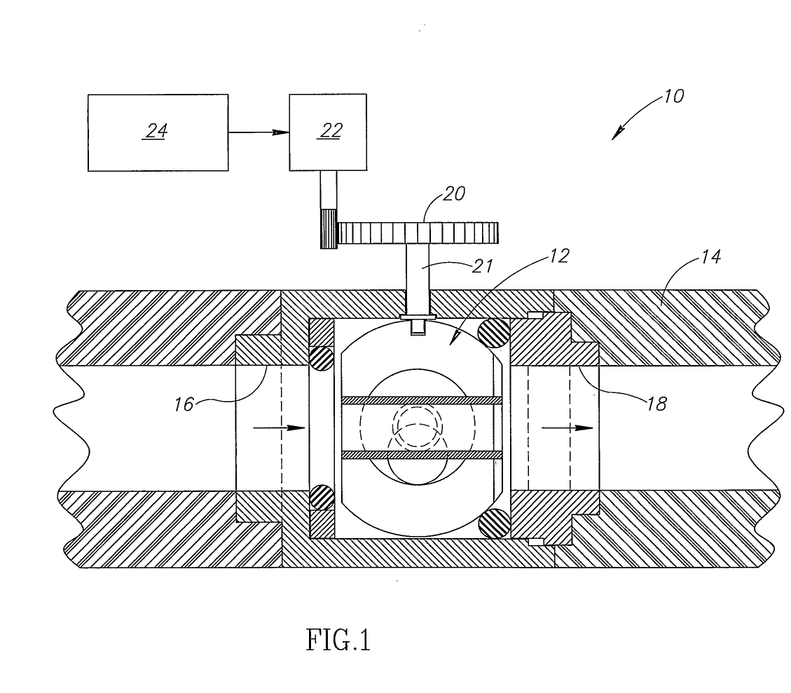

Referring now to FIG. 1, there is shown a schematic sectional illustration of an anti-theft system 10 constructed and operative in accordance with one embodiment of the present invention. Anti-theft system 10 includes a ball assembly 12 mounted in a fluid line 14 carrying fluid to an hydraulic or pneumatic mechanism in the vehicle, such as brakes, steering wheel, fuel or gas supply, etc. Ball assembly 12 has a fluid inlet 16 and a fluid outlet 18, for connection in the fluid line, for instance, inside a pump, or between a fluid reservoir and a fluid destination. According to one embodiment of the invention, the anti-theft system 10 is mounted in a brake line, and fluid inlet 16 is coupled to a master cylinder (not shown), while fluid outlet 18 is coupled to a wheel cylinder (not shown).

A toothed wheel 20, which is coupled to a motor 22 or other rotation means, is coupled via a shaft 21 to ball assembly 12 to cause rotation of the valve. Preferably, a controller 24 is provided to control actuation of the motor 22.

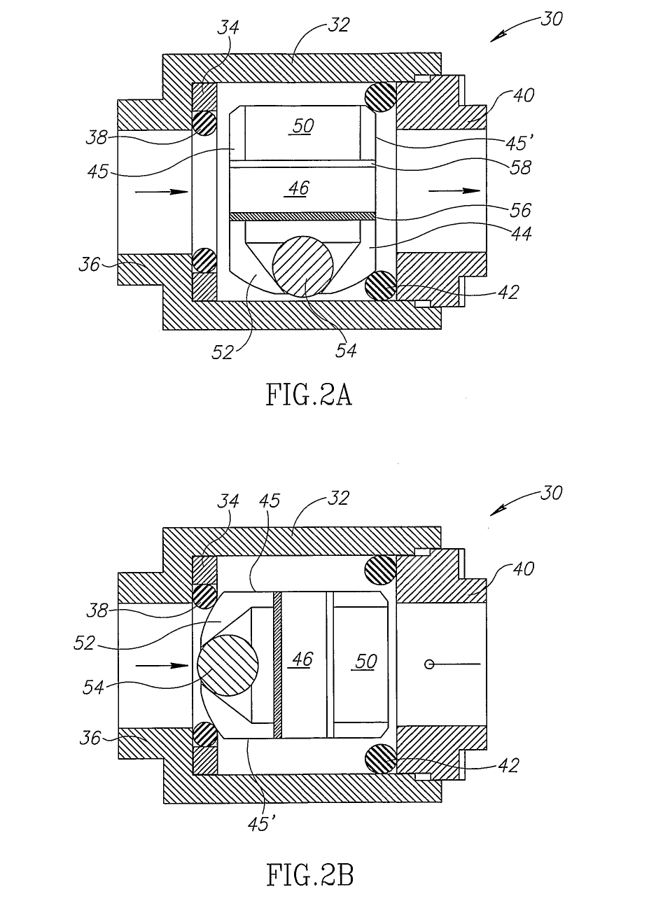

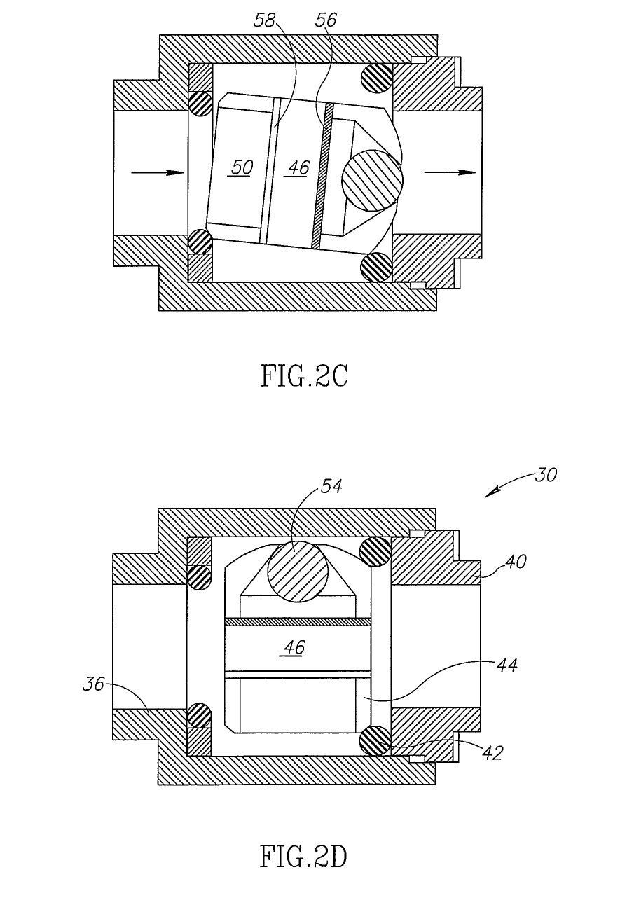

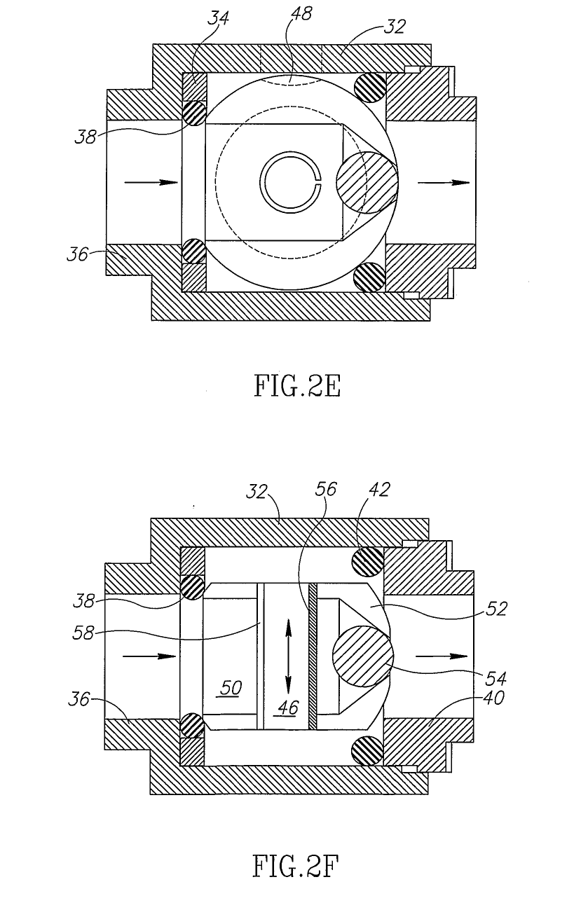

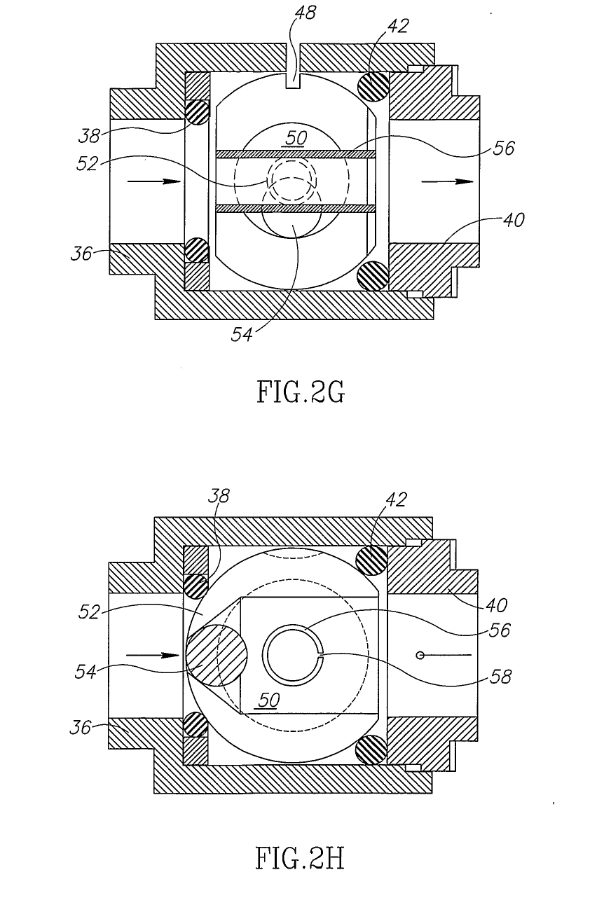

FIGS. 2a to 2h are schematic illustrations of an anti-theft valve 30 according to one embodiment of the invention, in operation. Anti-theft valve 30 includes a substantially hollow housing 32 having, at one end thereof, a fluid inlet 36. An annular seal 38 provides a seal for inlet 36. Annular seal 38 may be supported by a seal support 39 as shown, which may, alternatively, be an integral part of housing 32. At the other end thereof, housing 32 has a fluid outlet 40. Another annular seal 42 is provided in housing 32 to seal fluid outlet 42. The diameter of annular seal 42 is larger than that of annular seal 38. A ball assembly 44 is rotatably mounted inside housing 32. As can be seen, ball assembly 44 is truncated on two sides 45, 45′ so as to allow passage of fluid in most positions, as described below.

Ball assembly 44 includes a first throughgoing passageway 46 between truncated sides 45, 45′, which permits fluid flow in both directions through it. Ball assembly 44 also includes a second throughgoing passageway 50. Throughgoing passageway 50 defines a substantially cylindrical fluid passageway, and one end tapers to define a valve seat 52 in which is held a poppet 54, forming a check valve. In this embodiment of the invention, second throughgoing passageway 50 is perpendicular to first throughgoing passageway 46, and intersects first passageway 46. In such an embodiment, the valve comprises a uni-level passageway in two perpendicular directions.

Means for preventing the poppet 54 from falling out of ball assembly 44 are provided, here illustrated as a sleeve 56 having a longitudinal slit 58. Sleeve 56 seats in first passageway 46 and limits the motion of poppet 54. A groove 48 may be provided for receiving a shaft or other means for rotating valve 44.

Operation of anti-theft valve 30 is as follows. Ball assembly 44 can rotate within housing 32 in such a way that at least a portion of either the first or the second throughgoing passageway provides a fluid flow path from the fluid inlet 36 to the fluid outlet 40. It is a particular feature of the present invention that a fluid flow path in the reverse direction, from the fluid outlet 40 to the fluid inlet 36, is also provided in every position of ball assembly 44 except one, as described below. This allows a legitimate user to utilize the braking or other system at any position of the ball assembly, thereby preventing the possibility of inadvertent disconnection of the fluid line, in the unlikely event of malfunctioning of the anti-theft valve.

FIGS. 2a and 2g are respective top and side views of anti-theft valve 30 in a position for bi-directional operation. In this position, first throughgoing passageway 46 is aligned between the fluid inlet 36 and the fluid outlet 40, and fluid can flow as shown by the arrows, from a pump or master brake cylinder or other source of fluid through inlet 36, via first passageway 46, and out outlet 40 to a fluid destination, such as a wheel cylinder, so as to actuate a mechanism in the car, such as applying the brakes to stop. In addition, fluid can freely flow in the opposite direction, through fluid outlet 40, first passageway 46 and inlet 36, so as to release the mechanism, for example, so as to release the brakes.

When it is desired to lock a mechanism in a vehicle using anti-theft valve 30 (i.e., to arm the anti-theft system), ball assembly 44 is rotated to the position illustrated in FIGS. 2b and 2h, respective top and side views of anti-theft valve 30 in a position for uni-directional operation. In this position, second throughgoing passageway 50 is aligned between the fluid inlet 36 and the fluid outlet 40, and fluid can flow as shown by the arrow, from a pump or master brake cylinder or other source of fluid through inlet 36, via second passageway 50. The fluid passes through passageway 50 by pushing poppet 54 away from valve seat 52, so as to open the passageway 50, around retaining sleeve 56 and out outlet 40 to a fluid destination. However, in this position, pressure is trapped in housing 32. The pressure acting in this direction on poppet 54 acts to urge poppet 54 to sealingly seat against valve seat 52. In addition, any fluid flowing around ball assembly 44 is trapped inside housing 32, as the ball assembly sealingly engages annular seals 38 and 42. Thus, fluid cannot flow in the opposite direction, through fluid outlet 40, second passageway 50 and inlet 36 so as to release the mechanism, i.e., to release the brakes.

FIGS. 2e and 2f are respective side and top views of anti-theft valve 30 in an alternative position for bi-directional operation. In this position, too, second throughgoing passageway 50 is aligned between the fluid inlet 36 and the fluid outlet 40, and fluid can flow as shown by the arrows. In this case, fluid flows through inlet 36 and into second passageway 50. As fluid reaches sleeve 56, it enters via slit 58 and passes through first passageway 46 into hollow housing 32. As can be seen, ball assembly 44 is adapted and configured such that, in this position, it does not engage annular seal 42, so fluid can flow out through outlet 40 to a fluid destination. In addition, in this position, fluid can also flow in the opposite direction. Pressure acting on poppet 54 serves to open passageway 50. At the same time, fluid can flow around the rounded portion of the ball assembly forming valve seat 52, past annular seal 42 through first passageway 46 and out through second passageway 50 and inlet 36.

FIG. 2d is a top view of anti-theft valve 30 in an alternative position for bi-directional operation. This position shows ball assembly 44 rotated again so that first passageway 46 is aligned between the fluid inlet 36 and the fluid outlet 40, and fluid can flow as shown by the arrows and in the reverse direction (both directions).

Even in intermediate positions, such as that shown in top view in FIG. 2c, it can be seen that passage of fluid is provided, at least in the direction of the arrows so as to permit actuation of the mechanism in the vehicle. In this position, fluid can flow around ball assembly 44 between annular seals 38 and 42, and into second passageway 50, through slit 58 into first passageway 46 and through housing 32 out the outlet 40.

Thus, it will be appreciated that ball assembly 44 is designed such that, in every position of the ball assembly 44, a fluid flow path exists from the fluid inlet to and through the fluid outlet. In addition, a fluid flow path in the reverse direction, from the fluid outlet 40 to the fluid inlet 36, is provided in every position of ball assembly 44 except that shown in FIGS. 2b and 2h, in which poppet 54 seals valve seat 52 while annular seal 30 seals fluid inlet 36. In other words, when the device is unarmed, at any position of the ball assembly, the fluid can move freely through both directions, and the valve, when armed, is uni-directional, in such a way that by pressing the brake pedal, the brakes are locked and remain locked, even after the pedal is released. This provides the very important safety feature, when used in the brake system, of ensuring that, in any position of the ball assembly, the anti-theft valve of the present invention will not prevent application of the brakes so as to stop the vehicle.

According to one preferred embodiment of the invention, several anti-theft valves are mounted in a single system or vehicle. In this case, two or more of the valves may be coupled for synchronized operation.

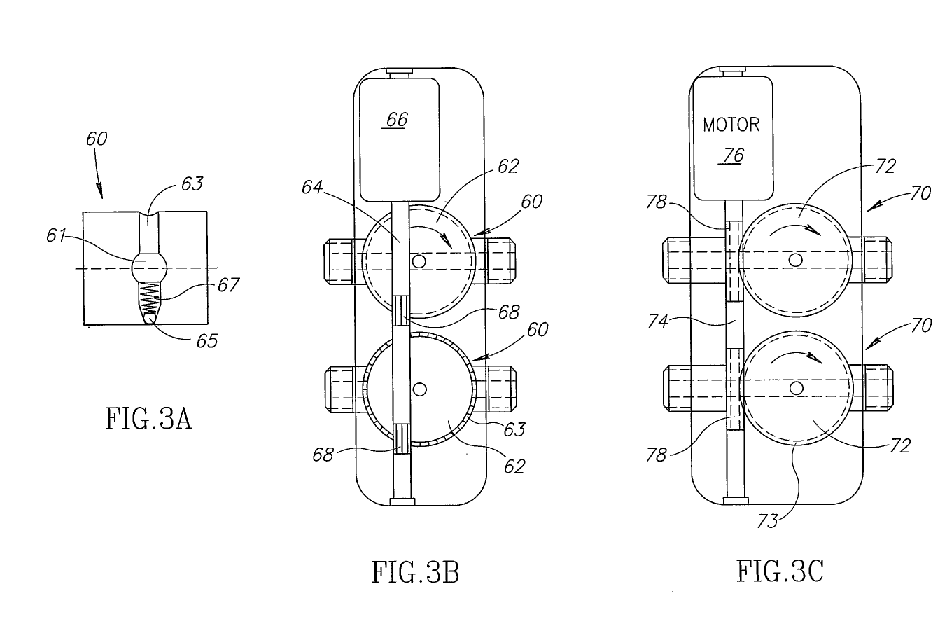

FIG. 3a is a schematic illustration of a ball assembly 60 for an anti-theft valve according to an alternate embodiment of the invention. A first throughgoing passageway 61 is provided through ball assembly 60 for two-directional fluid flow, and a second throughgoing passageway 63 is provided perpendicular to, and intersecting first throughgoing passageway 61. One end of second passageway 63 is tapered and holds a poppet 65, forming a check valve. In this embodiment, the retaining element 67 for the poppet 65 is a spring mounted in passageway 63. Operation of the valve with this ball assembly is substantially the same as that described above with regard to FIG. 2a.

FIGS. 3b and 3c are schematic top view illustrations of multiple-valve anti-theft systems, according to the invention. FIG. 3b shows two anti-theft valves 60 arranged for mounting in adjacent fluid lines, such as brake fluid lines. Each anti-theft valve 60 is coupled via a shaft to a gear wheel 62, having upstanding teeth 63, for rotating a ball assembly (not shown) inside the anti-theft valve. Gear wheel 62, in turn, is coupled via a transmission 64 to a motor 66. Transmission 64 consists of a shaft with two spur gears 68, each arranged to engage the upstanding teeth 63 of one gear wheel 62. In this way, operation of motor 66 causes transmission 64 to transfer the rotational movement to each of gear wheels 62 in a synchronized fashion. In this way, for example, the brakes of any number of wheels of a vehicle can be locked substantially simultaneously. Synchronized operation is preferred for proper functioning of the device, as well as for safety in operation.

FIG. 3c shows two anti-theft valves 70 arranged for mounting in adjacent fluid lines, such as brake fluid lines. Each anti-theft valve 70 is coupled via a shaft to a gear wheel 72, having teeth 73 around the periphery, for rotating a ball assembly (not shown) inside the anti-theft valve. Gear wheel 72, in turn, is coupled via a transmission 74 to a motor 76. In this embodiment, transmission 74 consists of a shaft with two worm gears 78, each arranged to engage the peripheral teeth 73 of one gear wheel 72. Operation of motor 76 causes transmission 74 to transfer the rotational movement to each of gear wheels 72 in a synchronized fashion to move the valves between their armed and disarmed positions. In this manner, no energy is required to maintain either the armed position or the disarmed position, so the anti-theft system according to the invention cannot be bypassed by energizing the gears. Also, this is a self-locking mechanism that ensures that the valve will not accidentally voluntarily rotate from a certain position to another. That is another safety measure of this embodiment.

Alternatively, each valve may have its own independent motor, and some or all of the motors can be electronically synchronized by a controller, by wired or wireless means. In this case, the valves need not be adjacent one another.

While the systems of the embodiments of FIGS. 3b and 3c have been illustrated with two anti-theft valves, it will be appreciated that, alternatively, any desired number of valves can be connected for synchronized operation.

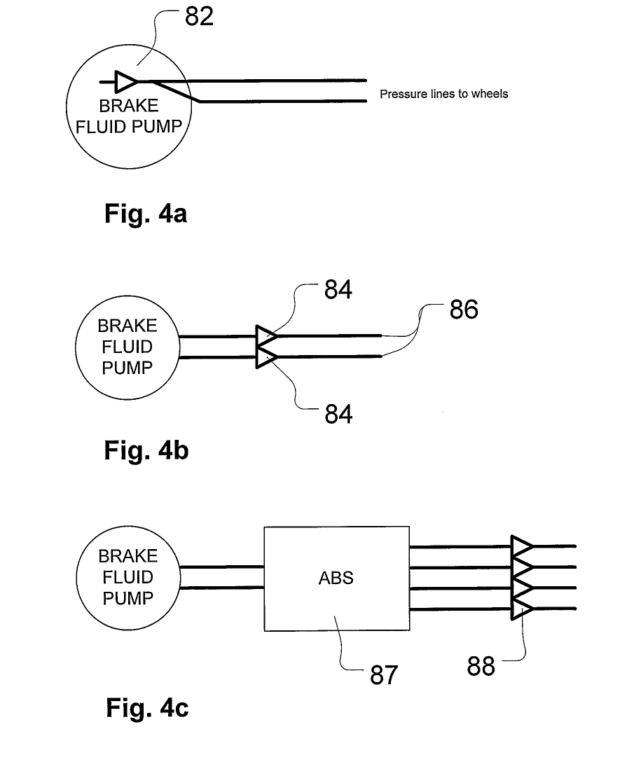

One preferred use for the anti-theft valves of the present invention is in brake fluid lines in a motor vehicle. FIGS. 4a, 4b and 4c are schematic illustrations of alternative valve locations for anti-theft systems according to the invention. The valves are to be placed between the vehicle braking system pump and the wheels. In FIG. 4a, a single anti-theft valve 80 is disposed inside the brake fluid pump 82. In this way, a single valve can control the brakes to all the vehicle wheels.

In FIG. 4b, a pair of anti-theft valves 84 is disposed inside a pair of pressure lines 86, each leading to two wheels. Synchronized actuation of these two valves can control the brakes to all the vehicle wheels.

Alternatively, in FIG. 4e, four anti-theft valves 88 are disposed inside four pressure lines 89 leaving an ABS 87, one coupled to the brakes on each wheel. These valves may be coupled to one another so that a single actuator can control the brakes on all the vehicle wheels. In this embodiment, (e.g., where an ABS system is found in the car and there is no space to put the valves and its controller before the ABS system), four valves are used. Alternatively, two valves may be used, and these may be placed between the brake pump and the ABS system.

Thus, a single motor can regulate the movement of 1 to N valves synchronously using a generic connecting element, as provided by these or alternative embodiments of the invention. It will be appreciated that, in each of these embodiments, a controller (not shown) is provided in the vehicle to permit arming of the anti-theft system. The controller may include a panel on the dashboard, through which the arming/disarming is accomplished, using an identification element such as a normal car key, biometry, coded radio frequency key, etc. If desired, a remote control device, a biosensor or a code pad may be provided for arming the system.

In one embodiment, the system is passively armed, and activation of the identification element disarms it. An example of passive aiming of the system includes an automatic arming that occurs when the engine is switched off. In another embodiment, the system is actively armed, e.g., the user activates a remote control when leaving the car. To disarm the system upon returning to the car, the user activates the remote control again.

It will be appreciated that the use of more than one valve makes it significantly more complicated to steal a vehicle. It might be possible to neutralize the effect of a single valve. However, when plurality of valves is placed in all relevant pressure lines, thereby disabling the braking system as well as the steering system, there would then be no point for a thief in stealing the vehicle by trying to drive it without braking or steering systems.

To prevent bypassing the valves, they may be connected directly to the pump, as shown in FIG. 4a, for example, such that there is no access to the inlet side of the valves. In this embodiment, when a pump manufacturer uses the valves inside the pressure pump, a potential thief would lose a lot of time in trying to bypass or disable the locking system of the braking and/or steering system according to the present invention.

In order to have a standard set of valves that will be suitable for different kinds of pumps, a non-centric adapter is used to adjust for the different sizes of the brakes pump outlets to fit the size of the anti-theft system's inlets.

Typically, the device has a fail-safe mechanism, which means that when necessary, the brakes can be activated to stop the vehicle. Correspondingly, the device typically ensures that while an authorized user is using the vehicle, no sudden unwanted braking will occur. This principle works with respect to the power steering, as well.

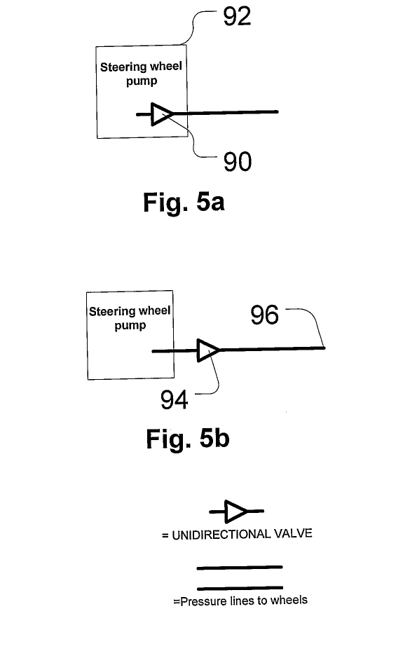

According to one embodiment of the invention, an anti-theft mechanism can be used on the power steering system. See, for example, FIGS. 5a and 5b, schematic illustrations of anti-theft systems according to additional embodiments of the invention. In these embodiments, the valve, when armed, is unidirectional, in such a way that by turning the steering wheel, the wheel direction is locked and remains locked, even after the steering wheel is released. This disables proper turning of the vehicle (e.g., by locking the wheels in a position to the left or right, once the would-be thief has turned the wheels in that direction). In the embodiment of FIG. 5a, an anti-theft valve 90 is disposed inside the steering wheel pump 92, thus preventing access for bypassing. In the embodiment of FIG. 5b, the anti-theft valve 94 is disposed inside the pressure line 96 to the steering wheel.

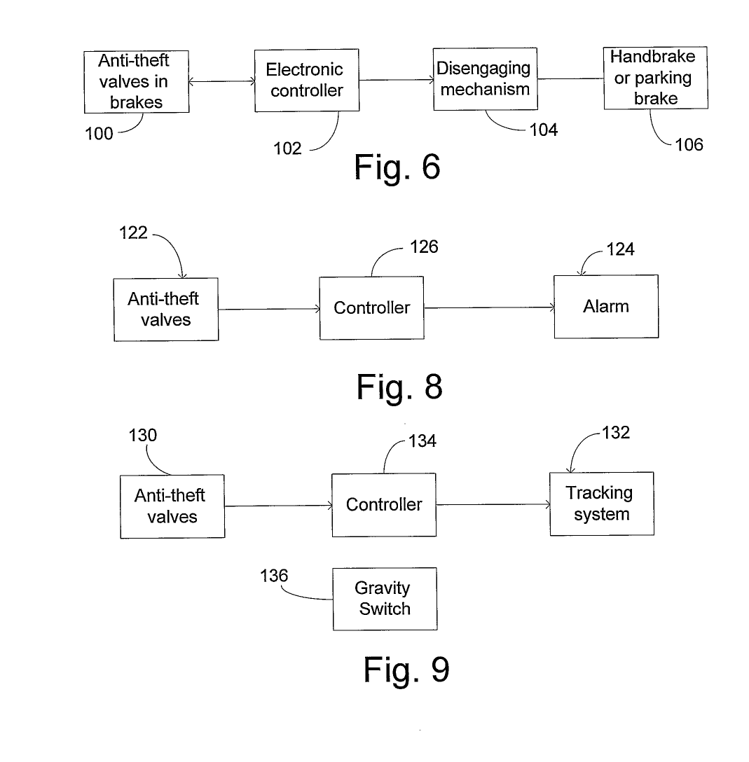

FIG. 6 is a block diagram illustration of an anti-theft system, according to a preferred embodiment of the invention. In this system, one or more anti-theft valves 100 are installed in the vehicle brakes, and coupled to an electronic controller 102 for arming and disarming. In addition, a disengaging mechanism 104, coupled to the mechanical handbrakes 106 of the vehicle, is also coupled to electronic controller 102. In this embodiment, when an unauthorized person starts the vehicle, its mechanical brakes (i.e., non-fluid-based brakes) such as hand brake or parking brake must be rendered non-operational by the thief in combination with the above mentioned anti-theft valves. Therefore, it becomes impossible to stop the car in any way when the elements (the valve on the pressure line and the disengaging mechanical part) are cut off or bypassed. The necessity for the thief to cause such damage to the vehicle is a strong disincentive against stealing the vehicle. Braking elements such as the parking brake and hand brake can be neutralized, by making them be always-on during unauthorized use. In order for the thief to bypass this always-on state of the parking and/or hand brake, the thief must disable them. As noted, there is a strong disincentive to disabling these brakes if the thief wants to drive the car away.

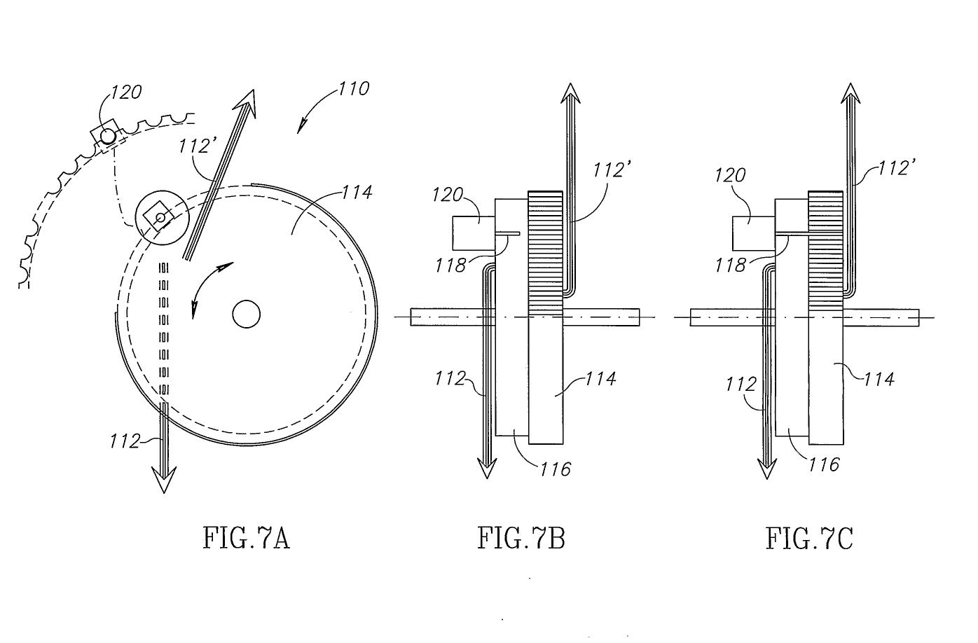

FIGS. 7a, 7b and 7c are schematic plan, top and alternative top illustrations of a handbrake/parking brake neutralizing mechanism 110 according to one embodiment of the invention. First, the cable of the brake is cut in two pieces 112, 112′. One piece 112′ of the cable is coupled to a toothed wheel 114, and the other piece 112 of the cable is coupled to a smaller, non-toothed wheel 116. A movable pin 118 is coupled to non-toothed wheel 116 and arranged for releasable engagement with toothed wheel 114. A solenoid 120 is coupled to non-toothed wheel 116 for actuating pin 118 for releasable engagement with toothed wheel 114. Thus, when the hand brake or parking brake is operative, and the pin 118 is in the engaging position, there is co-rotation of toothed wheel 114 and non-toothed wheel 116. This means, that when the hand brake is operated by the driver, cable 112′ is pulled and, via the co-rotation of the toothed and non-toothed wheels, cable 112 is also pulled, thereby actuating the brakes. On the other hand, when the brake mechanism is neutralized, there is free rotation of toothed wheel 114 relative to non-toothed wheel 116, so that, when cable 112′ is pulled by a thief, the cable 112 does not operate the handbrake/parking brake. Preferably, the controller for arming/disarming the system is coupled to solenoid 120 for controlling the releasable engagement of pin 118 with toothed wheel 114. Preferably neutralization of the hand brake is synchronized with arming of the main brake system. Alternatively, the solenoid may be coupled to the automatic and passive arming arrangement of the system, as described above, for coordinated operation.

When the anti-theft system in the vehicle is armed, as shown in FIG. 7b, the pin 118 is removed from between the teeth of toothed wheel 114 by solenoid 120. When the operator operates the handbrake/parking brake cable 112′ rotates toothed wheel 114 in free rotation and cable portion 112 is not pulled by non-toothed wheel 116 thus the brakes are not actuated. On the other hand, when the system is disarmed for normal vehicle use, as shown in FIG. 7c, engaging pin 118 is moved to engage the teeth of toothed wheel 114, causing co-rotation of wheels 116 and 114. Thus, when the operator operates the handbrake/parking both cable portions 112 and 112′ are pulled, resulting in the mechanical actuation of the brakes.

In order to increase the overall anti-theft protection provided to a vehicle, the anti-theft system of the present invention may be utilized in conjunction with other methods of preventing or discovering theft of the vehicle. For example, in one embodiment, shown in FIG. 8, the anti-theft device 122 as described above is used in combination with an alarm system 124. A controller 126 may be provided to coordinate between the two.

In another embodiment, shown in FIG. 9, the anti-theft system 130 of the present invention is used in combination with a tracking system device 132. Here, too, a controller 134 is preferably provided to synchronize between the two. Optionally, a weight switch 136 may be used, in addition, for determining if the vehicle is being lifted. In response to such a determination, a signal is typically transmitted to a tracking system controller and/or to the owner of the vehicle.

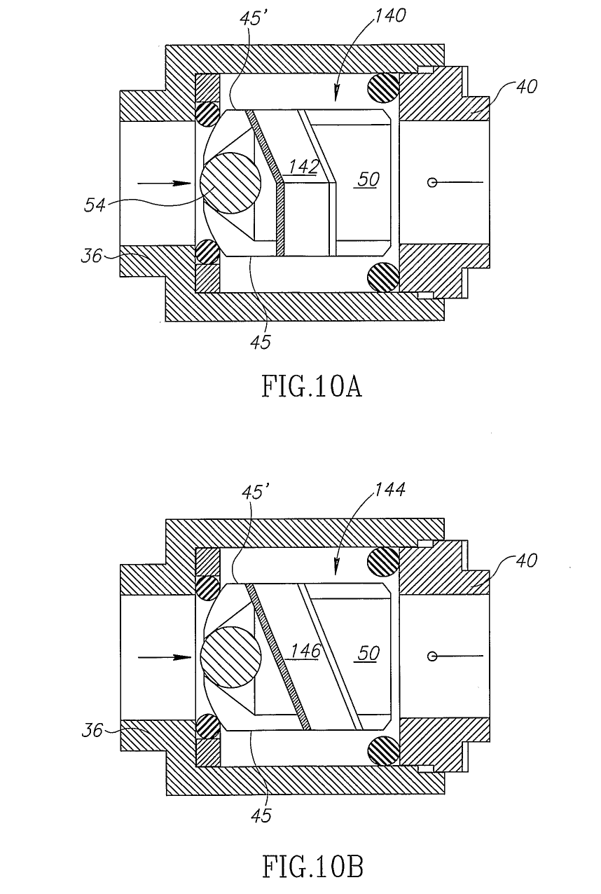

Referring now to FIG. 10a, there is shown a schematic illustration of a rotary valve with a ball assembly 140 according to another embodiment of the invention. Ball assembly 140 is substantially similar to ball assembly 44 of FIG. 2a, and like elements have like reference numerals. However, in ball assembly 140, the first fluid passageway 142 is not a straight passageway, but rather is angled from one truncated wall 45 to the other 45′. It will be appreciated that passageway 142 need not necessarily be of constant diameter along its length. Operation of this embodiment is the same as that of the embodiment of FIG. 2a, so will not be described again.

FIG. 10b is a schematic illustration of a rotary valve with a ball assembly 144 according to an alternative embodiment of the invention. Ball assembly 144 is substantially similar to ball assembly 44 of FIG. 2a, and like elements have like reference numerals. However, in ball assembly 144, the first fluid passageway 146 is not perpendicular to second passageway 50, but rather is angled relative thereto as it passes from one truncated wall 45 to the other 45′. Operation of this embodiment is the same as that of the embodiment of FIG. 2a, so will not be described again.

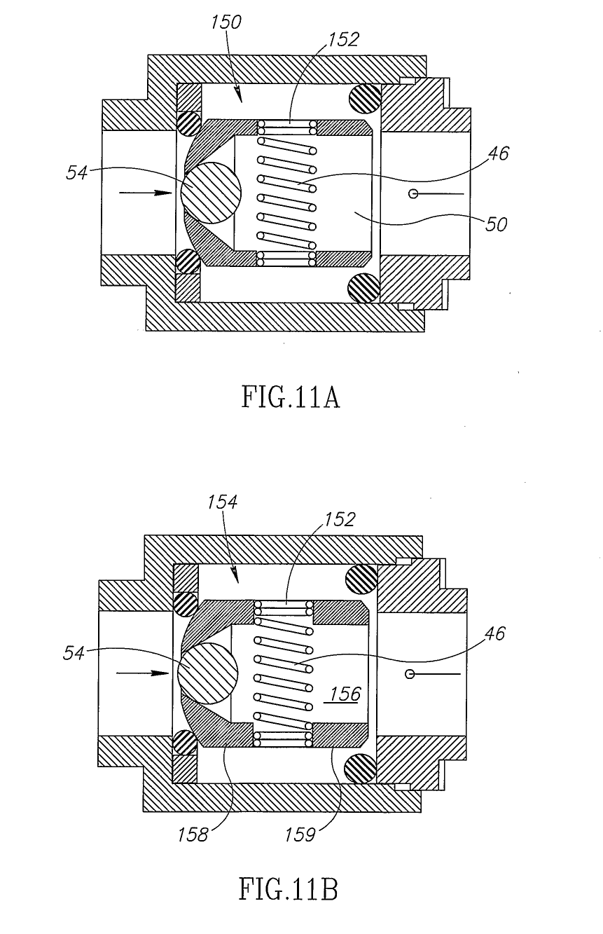

FIG. 11a shows schematically a rotary valve with a ball assembly 150 according to an alternative embodiment of the invention. Ball assembly 150 is substantially similar to ball assembly 44 of FIG. 2a, and like elements have like reference numerals. However, in ball assembly 150, the retaining means holding poppet 54 inside ball assembly 150 is a spring 152. As can be seen, spring 152 is mounted inside passageway 46, concentric with its longitudinal axis, and permits fluid to flow through passageway 50, but prevents poppet 54 from falling out of ball assembly 150 together with the fluid. It will be appreciated by those skilled in the art that other poppet retaining elements can be utilized, as long as they permit fluid flow through the intersecting bores, while preventing release of the poppet.

FIG. 11b is a schematic illustration of a rotary valve with a ball assembly 154 according to a further embodiment of the invention. Ball assembly 154 is substantially similar to ball assembly 144 of FIG. 11a, and like elements have like reference numerals. However, in ball assembly 154, the diameter of passageway 156 is smaller than that of passageway 50 of FIG. 2a. In addition, the wall 158 of passageway 156 includes a cut out portion 159, which enlarges the fluid outlet from ball assembly 154. Thus, in this embodiment, passageways 46 and 156 essentially consist of individual inlets, one of which has a check valve, which merge into a common outlet. Operation of this embodiment is substantially the same as that of the embodiment of FIG. 2a, so will not be described again.

It will be appreciated that the structures of the anti-theft system described above provide improved safety over conventional devices, as they permit application of brakes, and activation of all the crucial systems in the vehicle, in any position of the ball assembly, and permit release of the system in all positions except the one in which the system is armed. Thus, in case of inadvertent rotation of the valve during driving, the driver will never find him or herself without brakes or steering.

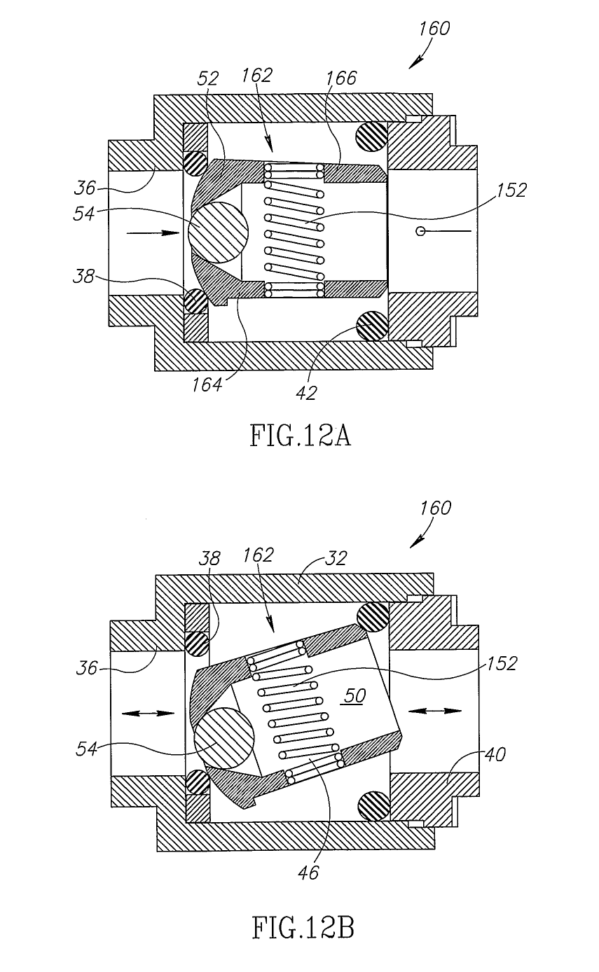

One of the possible design considerations which leads to this result is illustrated in FIGS. 12a and 12b, schematic illustrations of a rotary valve 160 according to another embodiment of the invention. In this embodiment, the ball assembly 162 of the valve is not truncated so as to form substantially parallel sides. Rather, this embodiment shows that is it possible to cut one side 164 of the ball assembly in a step fashion, and the other side 166 (or both sides) can be cut at an angle to the horizontal axis of the ball assembly. The requirement fulfilled by these designs of the rotary valve is that the diameter of the passage to the outlet (i.e., the inner diameter of annular seal 42) is larger than the diameter of the ball assembly between the truncated sides 164 and 166 near the inlet. In the illustrated embodiment, this can be described as: 2rₒ>L1+L2.

FIG. 12a shows the valve in the sealing position, where poppet 54 seats against valve seat 52, and the ball assembly sealingly engages annular seal 38, which seals the inlet 36.

FIG. 12b is a schematic illustration of the ball assembly of FIG. 12a in another position, this one permitting bi-directional fluid flow through the rotary valve. In this case, as can be seen, fluid can flow from inlet 36, pushing poppet 54 into the ball assembly until it is stopped by retaining spring 152, through valve seat 52, and both through passageway 50 and via spring 152 through passageway 46, and out the outlet 40. Fluid can also flow in the opposite direction, in through outlet 40, into ball assembly 166 through passageway 46 and/or through passageway 50, and out through housing 32 between the ball assembly and annular seal 38, to the inlet 36.

While the rotary valves described above all have two intersecting passageways, it will be appreciated that additional passageways through the ball assembly may be provided, as long as there remains one position of the ball assembly in which the check valve and seal 38 operate to seal the fluid inlet of the housing, permitting only uni-directional fluid flow.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description. It will further be appreciated that the invention is not limited to what has been described hereinabove merely by way of example. Rather, the invention is limited solely by the claims which follow.

1. A rotary valve having a fluid inlet and a fluid outlet, the rotary valve comprising:
a housing for mounting in a fluid line controlling an hydraulic or pneumatic system; and
a ball assembly mounted in said housing, the ball assembly including:
at least two intersecting fluid flow passageways, and
a check valve mounted in one end of one of said passageways;
said ball assembly and said housing being configured and adapted to permit fluid flow through the housing from the fluid inlet to the fluid outlet in all positions of the ball assembly, and to permit fluid flow through the housing from the fluid outlet to the fluid inlet in all except one position of the ball assembly, in which one position said check valve maintains pressure in the fluid line for locking said hydraulic or pneumatic system.

2. The rotary valve according to claim 1, wherein:
said housing includes the fluid inlet and the fluid outlet, further comprising:
a first annular seal mounted in said housing adjacent said fluid inlet;
a second annular seal mounted in said housing adjacent said fluid outlet, said second seal having a larger inner diameter than said first seal;
said ball assembly is mounted in said housing between the first seal and the second seal, said ball assembly including:
first and second opposing truncated sides;
a first fluid flow passageway extending between said first and second truncated sides, and permitting bi-directional fluid flow therethrough from said first truncated side to said second truncated side and in reverse;
a second fluid flow passageway extending through said ball assembly, intersecting said first fluid flow passageway, and having a valve seat and a poppet mounted at one end of said second passageway forming said check valve, to prevent, together with said second seal, fluid flow from said fluid outlet to said fluid inlet in said one position of said ball assembly;
a poppet retaining element mounted in said ball assembly; and
further comprising means for rotating said ball assembly between a bi-directional fluid flow position and said one position.

3. The rotary valve according to claim 2, wherein one end of said first passageway merges with one of said second passageway opposite said check valve.

4. The rotary valve according to claim 1, wherein:
said housing includes the fluid inlet and the fluid outlet, further comprising:
a first annular seal mounted in said housing adjacent said fluid inlet;
a second annular seal mounted in said housing adjacent said fluid outlet, said second seal having a larger inner diameter than said first seal;
wherein said ball assembly is mounted in said housing between the first seal and the second seal, said ball assembly including;
first and second opposing truncated sides;
a first fluid flow passageway extending between said first and second truncated sides, and permitting bi-directional fluid flow therethrough from said first truncated side to said second truncated side and in reverse;
a second fluid flow passageway extending through said ball assembly, substantially perpendicular to and intersecting the first fluid flow passageway, said second fluid flow passageway having a valve seat and a poppet mounted at one end thereof and forming said check valve, to prevent, together with said seal, fluid flow from said fluid outlet to said fluid inlet in said one position of said ball assembly;
a poppet retaining element mounted in said ball assembly; and
further comprising means for rotating said ball assembly between a bi-directional position and said one position.

5. The valve according to claim 2, wherein a diameter of one end of said second passageway is larger than a diameter of the poppet, while a second end of said second passageway is tapered to a diameter smaller than the diameter of the poppet, to serve as the valve seat for the check valve.

6. The valve according to claim 1, further comprising a controller for controlling rotation of said ball assembly by controlling said means for rotating.

7. The valve according to claim 2, wherein said poppet retaining element is a sleeve with a longitudinal slit.

8. The valve according to claim 2, wherein said poppet retaining element is a spring mounted in said first passageway.

9. An anti-theft system comprising:
at least open rotary valve including:
a housing having a fluid inlet and a fluid outlet for coupling in a fluid line,
a first annular seal mounted in said housing adjacent said fluid inlet;
a second annular seal mounted in said housing adjacent said fluid outlet, said second seal having a larger inner diameter than said first seal;
a ball assembly mounted in the housing between the first seal and the second seal, said ball assembly including:
first and second opposing truncated sides;
a first fluid flow passageway extending between said first and second truncated sides, and permitting bi-directional fluid flow therethrough from said first truncated side to said second truncated side and in reverse;
a second fluid flow passageway extending through said ball assembly, intersecting said first fluid flow passageway, and having a valve seat and a poppet mounted at one end thereof to form a check valve, to prevent, together with said second seal, fluid flow from said fluid outlet to said fluid inlet in one position of said ball assembly;
a poppet retaining element mounted in said ball assembly; and
means for rotating said ball assembly between a bi-directional position and said one position; and
a controller for controlling said means for rotating.

10. The anti-theft system according to claim 9, including:
a plurality of said rotary valves, each adapted for mounting in a different fluid line;
a coupler for coupling said plurality of rotary valves; and
wherein said means for rotating includes means for synchronously rotating each of said plurality of valves between a bi-directional position and said one position.

11. The system according to claim 9, further comprising means for actuating said controller to arm said system by activating said means for rotating.

12. The system according to claim 11, wherein said means for actuating is selected from; a remote control device, a biosensor, a keypad, or a code pad.

13. The system according to claim 9, further comprising adapters couplable to said fluid inlet and said fluid outlet for mounting said valve in a fluid line in an hydraulic or pneumatic system of a vehicle, said fluid inlet and said fluid outlet being connectable in said fluid line via said adapters.

14. The system according to claim 13, wherein said fluid line is a brake fluid line.

15. The system according to claim 13, comprising a plurality of fluid lines in at least one hydraulic or pneumatic system of a vehicle, and a plurality of valves, one said valve being mounted in each of said fluid lines.

16. The system according to claim 15, further comprising means for coupling said plurality of valves for synchronous rotation.

17. The system according to claim 9, and further comprising means for neutralizing a handbrake of said vehicle.

18. The system according to claim 17, wherein said means for disengaging a handbrake includes:
a toothed wheel;
a non-toothed wheel mounted adjacent said toothed wheel;
a movable pin coupled to non-toothed wheel and arranged for releasable engagement with said toothed wheel;
a solenoid coupled to said non-toothed wheel for actuating said pin for releasable engagement with toothed wheel; and
said toothed wheel being adapted and configured to engagingly receive a first portion of a handbrake cable; and
said non-toothed wheel being adapted and configured to engagingly receive a second portion of said handbrake cable, whereby said handbrake can be engaged only when said movable pin engages said toothed wheel.

19. The system according to claim 17, wherein said controller is coupled to said means for neutralizing a handbrake for synchronized operation.

20. The system according to claim 13, wherein said fluid line is a steering wheel fluid line.

21. The system according to claim 9, further comprising an alarm system mounted in the vehicle and means coupling said rotary valve to said alarm system for selectively activating an alarm.

22. The system according to claim 9, further comprising tracking means mounted in the vehicle for locating said vehicle.

23. A method for forming a rotary valve comprising:
providing a rotary valve housing having a fluid inlet and a fluid outlet, for mounting in a fluid line controlling an hydraulic or pneumatic system;
mounting a ball assembly in the housing, the ball assembly including:
at least two intersecting fluid flow passageways; and
a check valve mounted in one end of one of said passageways;
the ball assembly and the housing being configured and adapted to permit fluid flow through the housing from the fluid inlet to the fluid inlet in all positions of the ball assembly, and to permit fluid flow through the housing from the fluid outlet to the fluid inlet in all except one position of the ball assembly, in which one position the check valve maintains pressure in the fluid line for locking the hydraulic or pneumatic system.

24. The method according to claim 23, comprising:
mounting a first annular seal in said housing adjacent said fluid inlet;
mounting a second annular seal in said housing adjacent said fluid outlet, said second seal having a larger inner diameter than said first seal;
mounting said ball assembly in said housing between the first seal and the second seal, said ball assembly including:
first and second opposing truncated sides;
a first fluid flow passageway extending between said first and second truncated sides, and permitting bi-directional fluid flow therethrough from said first truncated side to said second truncated side and in reverse;
a second fluid flow passageway extending through said ball assembly, intersecting said first fluid flow passageway, and having a valve seat and a poppet mounted at one end of said second passageway forming said check valve, to prevent, together with said second seal, fluid flow from said fluid outlet to said fluid inlet in said one position of said ball assembly;
a poppet retaining element mounted in said ball assembly; and
coupling means for rotating said ball assembly between a bi-directional fluid flow position and said one position to said ball assembly.

25. A method for forming an anti-theft system, the method comprising:
providing at least one rotary valve including:
a housing at least one rotary valve including:
a housing having a fluid inlet and a fluid outlet for coupling in a fluid line,
a first annular seal mounted in said housing adjacent said fluid inlet;
a second annular seal mounted in said housing adjacent said fluid outlet, said second seal having a larger inner diameter than said first seal;
a ball assembly mounted in the housing between the first seal and the second seal, said ball assembly including:
first and second opposing truncated sides;
a first fluid flow passageway extending between said first and second truncated sides, and permitting bi-directional fluid flow therethrough from said first truncated side to said second truncated side and in reverse;
a second fluid flow passageway extending through said ball assembly, intersecting said first fluid flow passageway, and having a valve seat and a poppet mounted at one end thereof to form a check valve, to prevent, together with said second seal, fluid flow from said fluid outlet to said fluid inlet in one position of said ball assembly;
a poppet retaining element mounted in said ball assembly; and
coupling means for rotating said ball assembly between a bi-directional position and said one position to the ball assembly; and
coupling an arming/disarming controller for controlling said means for rotating to the means for rotating.

26. The method according to claim 25, further comprising providing a handbrake neutralizing mechanism and coupling it to said arming/disarming controller for synchronized operation.

27. The method according to claim 25, further comprising providing a steering wheel neutralizing mechanism and coupling it to said arming/disarming controller for synchronized operation.

28. The method according to claim 25, further comprising providing an alarm system and coupling it to said arming/disarming controller.

29. The method according to claim 25, further comprising providing a tracking system and coupling it to said arming/disarming controller.
